(19) United States
(12) Patent Application Publication
(10) Pub. No.: US 2011/0030865 A1
(43) Pub. Date: Feb. 10, 2011

(54) FOAM FILLED TIRE

(75) Inventors: Katherine Ann Folk, Uniontown, OH (US); George Frank Balogh, North Canton, OH (US); Maurice Jacob Frank, North Canton, OH (US); Leonard James Reiter, Norton, OH (US); Brian Ernest McMahon, Akron, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(73) Assignee: The Goodyear Tire & Rubber Company

(21) Appl. No.: 12/904,456

(22) Filed: Oct. 14, 2010

Related U.S. Application Data
(62) Division of application No. 11/942,051, filed on Nov. 19, 2007.
(60) Provisional application No. 60/875,791, filed on Dec. 19, 2006.

(51) Int. Cl. B60C 7/00; B29D 30/02

(52) U.S. Cl. 152/310; 156/113

(57) ABSTRACT

The present invention relates to a pneumatic tire having its internal cavity filled with a closed cellular rubber contained within the tire cavity by a non-foamed rubber layer.

The Applicants hereby claim the benefit of prior U.S. application Ser. No. 11/942,051, filed Nov. 19, 2007, which claims the benefit of prior provisional U.S. Application Ser. No. 60/875,791, filed on Dec. 19, 2006.

### FIELD OF INVENTION

The present invention relates to a pneumatic tire having its internal cavity filled with a closed cellular rubber contained within the tire cavity by a non-foamed rubber layer.

### BACKGROUND OF THE INVENTION

Tires having their cavities filled with closed cell rubber foam are sometimes used for various applications, particularly where it is desired to maintain associated vehicles in service for extended periods of time without loss of time for vehicular use. It is known to fill tires with a closed cellular rubber foam to form foam filled tires which are substantially deflation proof and have significant resistance to destruction by typical hazards such as for example, bolts, nails, sharp rocks, road pot-holes and the like. Therefore, use of such tires typically significantly reduces the time that such vehicles are down for repair and not available for useful service.

For example, see U.S. Pat. Nos. 3,022,810, 3,381,735, 3,650,865, 3,872,201, 4,060,578 and 6,623,580.

Foam filled tires are typically prepared by inserting strips of foamable rubber (foam rubber precursor) into an already shaped and cured rubber tire cavity which is than mounted on a metal tire rim to form a wheel assembly thereof. The foam rubber precursor rubber composition contains a curative and heat activatable blowing agent. Upon heating the assembly, the foam rubber precursor simultaneously expands and cures to fill the tire and fit the closed cell filled tire tightly to the tire rim to resist slippage during operation of the wheel on an associated vehicle.

For some instances, it is desired to prepare the closed cellular foam filled tire in a manner that the foam filled tire can be fitted to a metal tire rim after the foam filled tire is prepared. In such instance, the tire with the foam precursor rubber layers in its cavity may be fitted to a cylindrical metal sleeve to form an assembly thereof wherein the surface of the metal sleeve is coated with a heat stable release agent. The assembly is heated to cause the foam precursor rubber composition to expand (foam) and cure to tightly fit, including the foam rubber under pressure, against the metal sleeve. The metal sleeve is then removed, with the foam rubber fitted tightly against it, and the foam filled tire is shipped to a user who may install the foam filled tire onto a metal wheel rim, by tightly fitting it, including the foam rubber, to the metal rim, for vehicular use.

A challenge is presented to protect the closed cellular rubber foam from damage as it is removed from such tightly fitting cylindrical metal curing sleeve and from future tight fitting installation onto a metal (cylindrical) tire rim.

For this invention, it is proposed to contain the closed cellular rubber foam within the tire cavity by a gum rubber barrier layer mounted within the tire cavity in a manner that such gum rubber barrier layer is co-cured with the foam rubber precursor rubber composition within the tire cavity in a manner that the rubber barrier layer is pressed out by the expanding foam rubber precursor to fit tightly against the metal curing sleeve as the expanding closed cellular rubber fills the tire cavity.

In the description of this invention, the term “phr” is used to designate parts by weight of an ingredient per 100 parts of elastomer unless otherwise indicated. The terms “elastomer” and “rubber” are used interchangeably unless otherwise indicated. The terms “cure” and “vulcanize” are used interchangeably unless otherwise indicated. The term “gum rubber” relates to a rubber composition that does not contain continuous cord reinforcement and as not thereby restrained from expansion by internal cord reinforcement, as is known to those having skill in such art.

The term “radial” where used, unless otherwise indicated, means a direction perpendicular to the axis of an intended rotation of a tire. The term “radially inward”, or “radially innermost”, where used, unless otherwise indicated, means a direction perpendicularly inward toward the axis of an intended rotation of a tire.

### SUMMARY AND PRACTICE OF THE INVENTION

In accordance with this invention, a pneumatic rubber tire is provided having its internal cavity filled with a closed cellular rubber covered by and contained within said tire cavity with a non-foamed rubber layer (said non-foamed rubber layer co-cured with said closed cellular rubber).

In accordance with this invention, a method for preparing a pneumatic tire having its internal cavity filled with a closed cellular foam rubber covered by and contained within said tire cavity with a non-foamed rubber layer which comprises:

(A) partially filling the cavity of a previously molded and cured pneumatic rubber tire with an uncured foamable rubber (e.g. partially filling said cavity with a plurality of layers of said foamable rubber);

(B) fitting an uncured non-foamable rubber layer on the radially innermost surface of said uncured foamable rubber and within said partially filled cured tire cavity to form a first assembly of said cured tire, uncured foamable rubber and uncured non-foamable rubber layer;

(C) fitting said first assembly onto a cylindrical curing metal sleeve to close said cured tire cavity which contains said foamable rubber and said non-foamable rubber layer with a air space between said cylindrical metal sleeve and said non-foamable rubber layer to form a second assembly comprised of said first assembly and said cylindrical metal sleeve;

(D) heating the combination of said assemblies to elevated temperature to cause:
(1) said foamable rubber to expand by forming a closed cellular structure, and to thereby:
   (a) press said non-foamable rubber layer against and to cure to the inner surface of said cured rubber tire cavity;
   (b) press said non-foamable rubber layer into said air space between said cylindrical metal rim and said non-foamable rubber layer and against the surface of said cylindrical curing rim; and
(2) co-curing of said foamable rubber and said non-foamable rubber layer in combination with said expanding of said foamable rubber.

In practice, said inner surface of said tire cavity contains an adhesive coating to aid adherence of said closed cellular rubber and said non-foamable layer to the sides of said tire cavity.

In further accordance with this invention, said curing sleeve is removed from said second assembly to form a cured tire with its internal cavity filled with said closed cellular rubber contained within said tire by said cured non-foamed rubber layer.

In this manner, then, a tire is provided having its internal cavity filled with a closed cellular rubber and an enclosing non-foamed rubber layer.

In one embodiment of the invention, said surface of said metal curing sleeve contains a heat stable release agent coating thereon to aid in enabling said removal of said cylindrical curing rim from said tire.

In further accordance with this invention, a wheel assembly is provided by fitting said tire having its internal cavity filled with a closed cellular rubber and an enclosing non-foamed rubber layer onto a metal cylindrical rim to form a wheel assembly.

In additional accordance with this invention, a wheel assembly is provided which is comprised of:

(A) a cylindrical metal tire rim, and

(B) a unitary tire assembly fitted onto said metal tire rim wherein said wheel assembly is comprised of a cured rubber tire having its internal cavity filled with a cured closed cellular rubber and having a cured non-foamed rubber layer pressed against the surface of said cylindrical metal tire rim and positioned on and cured to the radially innermost surface of said closed cellular rubber to thereby enclose and contain said closed cellular rubber within said tire cavity.

In one embodiment of this invention, the said foamable rubber layers positioned within said tire cavity are of a rubber composition which may be comprised of, for example:

(A) at least one diene-based rubber comprised of:
(1) cis 1,4-polyisoprene rubber, or
(2) about 25 to about 95 phr of cis 1,4-polyisoprene rubber and from about 5 to about 75 phr of at least one additional diene-based rubber;

(B) from about 3 to about 5 phr of heat activatable organoperoxide (free radical generating, (e.g. decompositional free radical peroxide generating) and from about 0.1 to about 0.5 phr of sulfur;

(C) heat activatable blowing agent (gas generating, such as for example, gas generating by decomposition of the blowing agent);

In one embodiment of the invention, said uncured unfoamable rubber layer may be comprised of a similar rubber composition except that it does not contain (is exclusive of) the blowing agent and is therefore comprised of:

(A) cis 1,4-polyisoprene rubber, or

(B) about 25 to about 95 phr of cis 1,4-polyisoprene rubber and from about 5 to about 75 phr of at least one additional diene-based rubber;

In one embodiment of this invention, said cavity of said cured rubber tire is from about 70 to about 90 percent filled with said combination of foamable rubber and non-foamable rubber layer such as, for example, filled to from about 75 to about 90 percent of the distance from the crown of the tire cavity to an imaginary line between the opening of the tire cavity (taking into account a likely imperfect fitting of the foamable rubber strips within the tire cavity).

The following Drawings are provided to further understand and illustrate the invention:

### BRIEF DESCRIPTION OF THE DRAWINGS

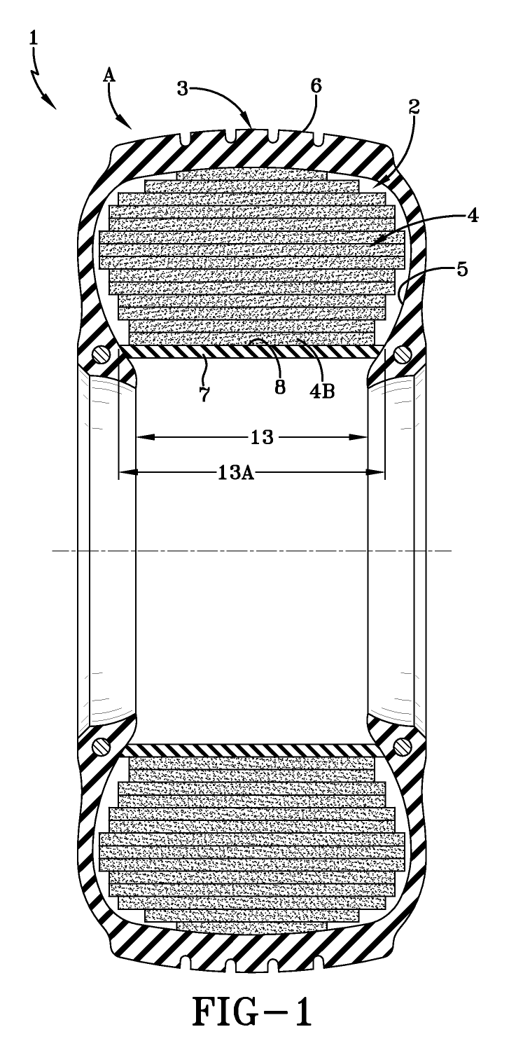

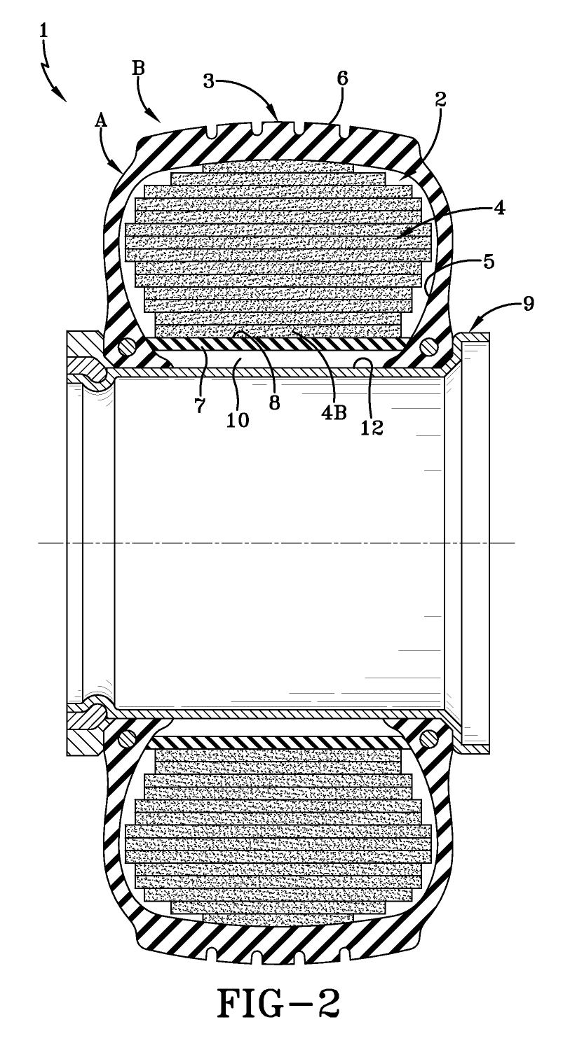

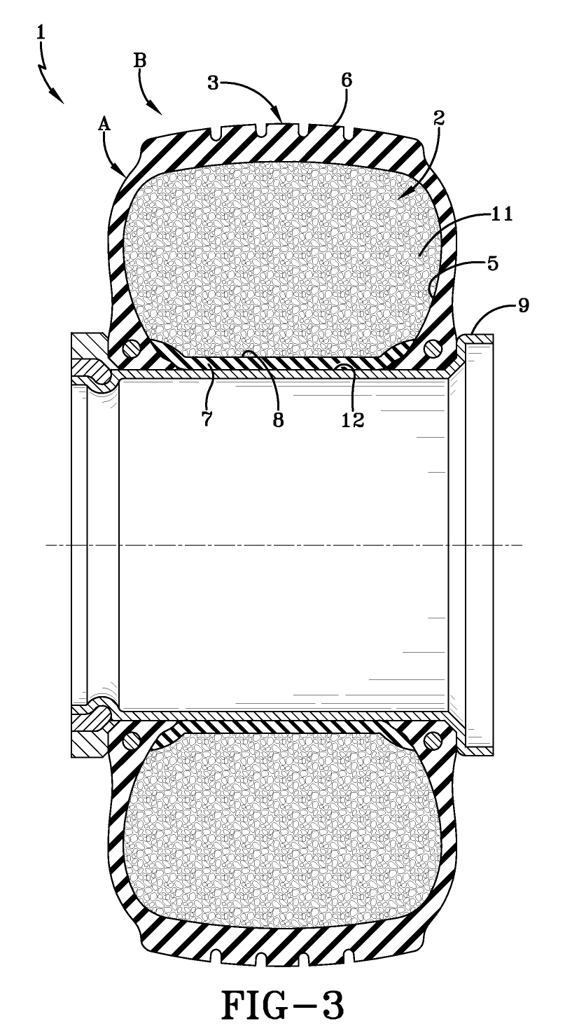

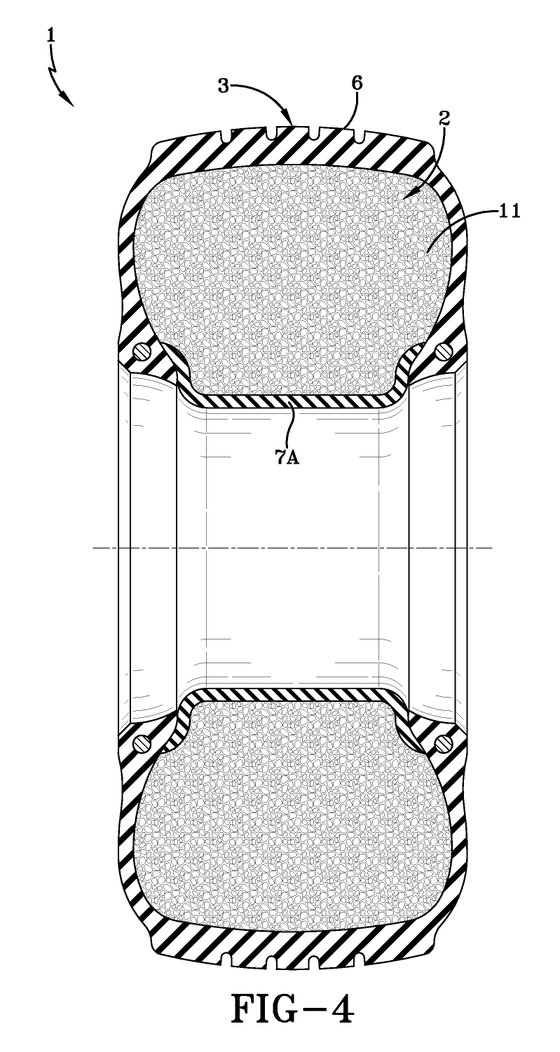

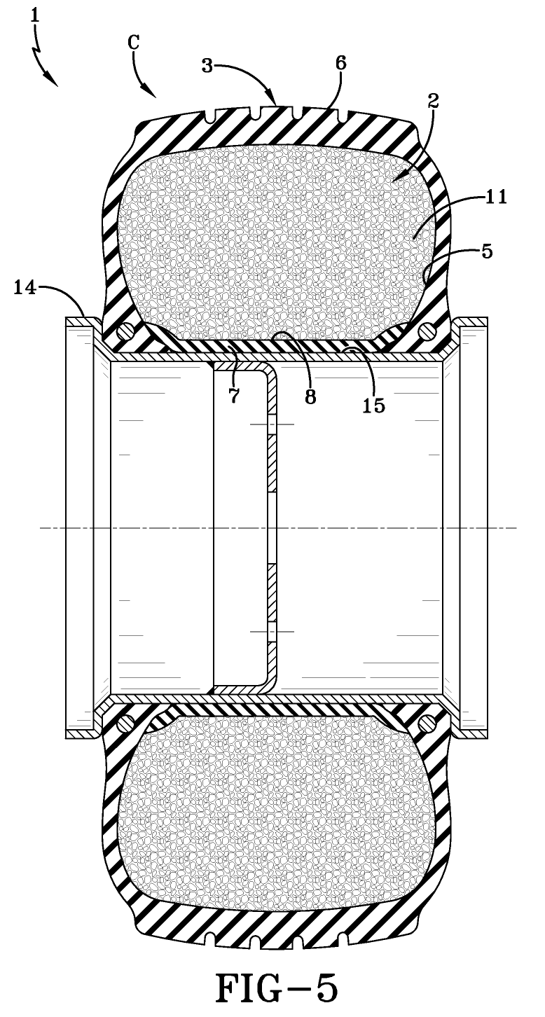

The accompanying Drawings (FIG. 1, FIG. 2, FIG. 3, FIG. 4 and FIG. 5) include a cross-sectional view of a tire with portions cut away to illustrate a preparation of a tire, and associated wheel assembly, wherein said tire is comprised of a pneumatic tire having its cavity filled with a closed cellular rubber with a non-cellular rubber layer positioned within said tire cavity and on the radially innermost surface of said closed cellular foam rubber to contain and enclose said closed cellular rubber within said tire cavity.

### THE DRAWINGS

In the Drawings, a pneumatic tire (1) is provided having a tire cavity (2).

In FIG. 1, a first assembly (A) is formed by placing a plurality of uncured foamable rubber strips (4) in an annular fashion within the cured tire cavity (2) to partially fill the tire cavity (2). An adhesive has been applied to the surface of the tire cavity (2) for increasing the adhesion of the layers of the strips (4) against the tire cavity surface (5).

Successive layers of the strips (4) are placed within the tire cavity to form a built-up uncured, foamable, rubber insert comprised of a plurality of the strips (4) in annular planes which are concentric and generally parallel to the annular plane of the tire tread (6). The width of the strips (4) somewhat approximates the width of the portion of the tire cavity (2) in which they are placed.

The successive layers of the strip (4) are generally substantially equal in thickness.

Alternately a continuous strip (4) of uncured, foamable rubber is spirally disposed within the tire cavity (2).

Alternately, for a relatively wide tire (1) the strips (4), or at least a portion of the strips (4), can be placed in a side-by-side relation within the tire cavity (2).

The quantity of foamable rubber composition for the strip (4) is somewhat related to its blowing agent content and a desired load bearing capability desired for the tire.

An uncured, non-foamable rubber layer (7) is positioned within the tire cavity (2) on the radially inner surface (8) of the radially innermost foamable rubber layer (4B) with its edges positioned against said adhesive coated cavity surface (5).

In FIG. 2, a second assembly (B) is formed by mounting the first assembly (A) comprised of the partially filled tire (1) containing the foamable uncured rubber strips (4) and unfoamable uncured rubber strip (7) in its cavity (2) on a rigid cylindrical metal curing sleeve (9), to which a heat stable release coating has been applied, to close the tire cavity (2) and thereby form a second assembly (B). The second assembly (B) includes an air space (10) between the curing sleeve (9) and uncured, non-foamable rubber layer (7) of the partially filled tire cavity (2).

The second assembly (B) is placed in an autoclave (not shown) and heated therein from room temperature (e.g. about 23° C.) to a temperature in a range of, for example, from about 100° C. to about 150° C. to activate the blowing agent to begin and continue its decomposition and associated gas formation as the temperature increases to

(A) expand and cure said foamable rubber and create a closed cellular pressurized foam rubber, while

(B) pressing said non-foamable rubber layer against the sides (5) of the tire cavity (2) and radially inwardly to cause the non-foamable rubber layer to cure and press against the surface (12) of the cylindrical metal curing sleeve (9).

In practice, as illustrated in FIG. 1, the width (13) of the non-foamable rubber layer (7) is wider than the width (13A) of the of the tire cavity (2) so that such rubber layer (7) is pressed radially outward in the tire cavity (2) by the expanding cellular rubber insert (11) in a wedge-like manner to physically press the said rubber layer (7) against the sides (5) of the tire cavity (2).

In FIG. 3, the second assembly (B) is shown with the tire cavity (2) filled with the combination of expanded, cured, closed cellular foam rubber insert (11) adhered against sides (5) of the tire cavity (2), and cured non-foamable rubber layer (7) pressed, under pressure created by the expanded closed cell foamed rubber insert (11) against the surface (12) of the cylindrical metal curing sleeve (9) and co-cured with, and thereby adhered to, the surface of the closed cellular rubber insert (7) with its edges adhered to the (adhesive coated) sides (5) of the surface of the tire cavity (2).

In FIG. 4 the tire (1) is shown as being removed from the cylindrical metal curing sleeve (9) and the cured non-foamable rubber layer is shown in a convex shaped expanded condition (7A) due to the significant pressure of the expanded closed cellular foamed rubber insert (11) enclosed by the combination of the tire cavity (2) and cured rubber layer (7A).

In FIG. 5, the tire (1) is shown being mounted on a cylindrical tire rim (14) to form a wheel assembly (C) thereof with the cured non-foamed rubber layer (7) being pressed against the surface (15) of the cylindrical tire rim (14) and the associated expanded closed cellular rubber insert (11) being in a compressed state against the cured non-foamed rubber layer (7).

A significant aspect of the invention is the contained, and thereby controlled) growth of closed cellular foam insert within the tire by the inserted non-foamable rubber layer positioned within and against the sides of the tire and on top of and co-cured with the radially innermost surface of the closed cellular rubber insert.

A further significant aspect of the invention is the protection (and improved appearance) of the closed cellular foam insert from damage-caused loss of the closed cellular foam (protection by the protective non-foamed rubber layer positioned on the radially inner surface of the closed cell insert) and associated loss of load carrying capacity of the tire.

Therefore, it is also considered herein that a new, novel tire which contains a cellular foam rubber, enclosed by a non-foamed rubber layer, in its cavity is provided as a significant departure from past practice for the preparation of a tire containing a closed cellular rubber as well as a wheel assembly comprised of such tire and, further, as well as a method of preparation of such a tire.

The following example is provided for a further understanding of the invention and is not intended to be limiting. The parts and percentages are by weight unless otherwise indicated.

### Example I

A sample of a rubber composition with blowing agent (Sample A) is proposed for the foamable rubber composition for a cured rubber tire insert and a sample of a rubber composition without a blowing agent (Sample B) is proposed for the unfoamable rubber layer and method illustrated in the accompanying Drawings.

Rubber Sample A and Sample B are illustrated in the following Table 1. The parts are by weight unless otherwise indicated.

TABLE 1

| | Parts | |
|---|---|---|
| | Sample A | |
| Material | (with blowing agent) | Sample B |
| Non-Productive Mixing Step | | |
| Cis 1,4-polyisoprene rubber¹ | 100 | 100 |
| Carbon black (N660)² | 20 | 30 |
| Medium rubber processing oil | 25 | 15 |
| Zinc oxide | 5 | 5 |
| Sulfur (0.2-0.5 parts, variable) | | |
| Mill, Open Roll, Mixing Step | | |
| Organo peroxide³ (6-8 parts, variable) | | |
| Blowing agent⁴ | 5 (variable) | 0 |

¹Synthetic cis 1,4-polyisoprene rubber
²A rubber reinforcing carbon black as N660, an ASTM designation
³Composite of 40 weight percent organoperoxide comprised of 1,1 Di(tert butyl peroxy) 3,3,5-trimethylcyclohexane and 60 weight percent ethylene/propylene rubber (thus 40 percent active) as Link-Cup TMCH 40MB ™ from Geo Specialty Chemical Company
⁴Blowing agent as a composite (75/25 weight ratio) of benzene sulfonyl hydrazide and oil reported in Table 1 as the composite.

### Example II

Exemplary illustrative pneumatic tires of sizes 12.00-20 28PR UMS-3A and 35x15-15 32 PR XTRWL are prepared by a method similar to the description and the accompanying Drawings

While certain representative embodiments and details have been shown for the purpose of illustrating the invention, it will be apparent to those skilled in this art that various changes and modifications may be made therein without departing from the spirit or scope of the invention.

1. (canceled)

2. A method for preparing a pneumatic rubber tire having its internal cavity filled with a closed cellular foam rubber covered by and contained within said tire cavity with a non-foamed rubber layer, which comprises:
(A) partially filling the cavity of a previously molded and cured rubber tire with an uncured foamable rubber (e.g. partially filling said cavity with a plurality of layers of said foamable rubber);
(B) fitting an uncured non-foamable rubber layer on the radially innermost surface of said uncured foamable rubber and within said partially filled cured tire cavity to form a first assembly of said cured tire, uncured foamable rubber and uncured non-foamable rubber layer;
(C) fitting said first assembly onto a cylindrical curing metal sleeve to close said cured tire cavity which contains said foamable rubber and said non-foamable rubber layer with a air space between said cylindrical metal rim and said non-foamable rubber layer to form a second assembly thereof;
(D). heating the combination of said assemblies to elevated temperature to cause:
(1) said foamable rubber to expand by forming a closed cellular structure, and to thereby:
(a) press said non-foamable rubber layer against and to cure to the inner surface of said cured rubber tire cavity;
(b) press said non-foamable rubber layer into said air space between said cylindrical metal curing sleeve and said non-foamable rubber layer and against the surface of said cylindrical curing sleeve; and
(2) co-curing of said foamable rubber and said non-foamable rubber layer in combination with said expanding of said foamable rubber.

3. The method of claim 2 wherein the surface of said tire cavity contains an adhesive coating to aid in adhering said closed cellular foam and said non-foamed rubber layer to the sides of said tire cavity.

4. The method of claim 2 wherein the surface of said cylindrical metal curing sleeve contains a heat stable release coating.

5. (canceled)

6. The method of claim 2 wherein said method further comprises removing said curing rim from said second assembly to form a cured tire with its internal cavity filled with said closed cellular rubber contained within said tire by said cured rubber layer.

7. (canceled)

8. (canceled)

9. (canceled)

10. (canceled)

11. (canceled)

12. The method of claim 2 wherein said foamable rubber layers are of a rubber composition comprised of:
(A) at least one diene-based rubber comprised of:
(1) cis 1,4-polyisoprene rubber, or
(2) about 25 to about 100 phr of cis 1,4-polyisoprene rubber and from zero to about 75 phr of at least one additional diene-based rubber;
(B) heat activatable organoperoxide; and
(C) heat activatable blowing agent.

13. The method of claim 2 wherein said uncured unfoamable rubber layer is of a rubber composition comprised of at least one diene-based rubber comprised of:
(A) cis 1,4-polyisoprene rubber, or
(B) about 25 to about 100 phr of cis 1,4-polyisoprene rubber and from zero to about 75 phr of at least one additional diene-based rubber.

14. (canceled)

15. (canceled)
